(19) United States
(12) Patent Application Publication
(10) Pub. No.: US 2021/0272176 A1
(43) Pub. Date: Sep. 2, 2021

(54) Motor Vehicle Data Retrieval, Processing and Presentation System and Method

(71) Applicant: Monroney Labels, LLC, Hilton Head Island, SC (US)

(72) Inventor: Nicole Michelle Beguesse, Hilton Head Island, SC (US)

(73) Assignee: Monroney Labels, LLC, Hilton Head Island, SC (US)

(21) Appl. No.: 17/321,680

(22) Filed: May 17, 2021

Related U.S. Application Data
(63) Continuation of application No. 15/159,953, filed on May 20, 2016, now abandoned.

(51) Int. Cl. G06Q 30/06; G06F 16/955

(52) U.S. Cl. CPC G06Q 30/0623; G06F 16/955; G06Q 30/0641

(57) ABSTRACT

A system and method for creating an accurate motor vehicle “window sticker” using a vehicle identification number and external data sources. A software application is provided that can be located on a smartphone. The smartphone has a processor, an associated memory, and a digital camera. The digital camera is used to take a photo of the vehicle's VIN plate. The software application reduces this photo to a character sequence representing the vehicle's unique VIN. The system next determines the vehicle make and model year using the VIN and in some instances other data sources. Once the vehicle make and model year is determined, the system determines the correct remote data source from which to request historical build data for that vehicle. A query is sent to the appropriate data source(s) and detailed information concerning the features and pricing for the particular vehicle is obtained. A data source adapter is then applied to transform the retrieved data from each source into a usable form.

### BACKGROUND OF THE. INVENTION

### 1. Field of the Invention.

This invention relates to the field of motor vehicles. More specifically, the invention comprises a method and system for retrieving information describing a particular motor vehicle from a plurality of different possible sources and presenting the information in a standardized, understandable format.

### 2. Description of the Related Art.

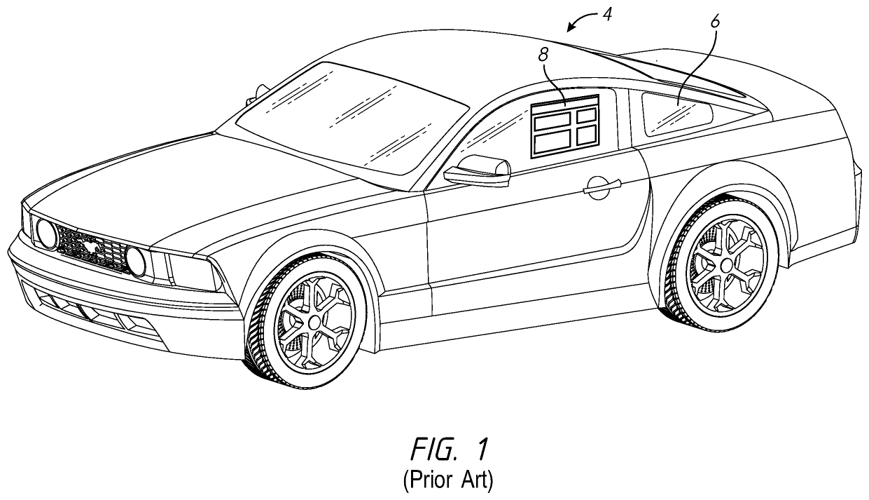

New motor vehicles sold in most major markets around the world have a “window sticker” that lists important feature and pricing information. FIG. 1 shows car 4 with an exemplary window sticker 8 in one of its windows 6. The window sticker allows a customer to quickly acquire relevant information.

Window stickers became somewhat standardized in the United States with the passage of the Automobile Information Disclosure Act of 1958. The passage of this act is most closely associated with Senator Mike Monroney of Oklahoma and—for this reason—window stickers are often referred to as “Monroney labels” or “Monroney stickers.” The original legislation required the disclosure of manufacturer's suggested retail pricing for the basic vehicle and for any optional equipment. Amendments over the years have added requirements for fuel economy information and crashworthiness information.

The current requirements in the United States are listed in Title 15 of the United States Code, section 1232. A compliant window sticker must include:

1. The make, model, and vehicle identification number;

2. The final assembly plant;

3. The identity of the dealer to whom the car is delivered, and the location of delivery;

4. The manufacturer's suggested retail price (“MSRP”) for the basic vehicle;

5. THE MSRP for each accessory or item of optional equipment;

6. The amount charged to the dealer for the transportation of the vehicle to the dealer;

7. The total MSRP for the vehicle; and

8. Safety ratings released by the U.S. National Highway Traffic Safety Administration.

Additional statutory provisions require the inclusion of warranty and fuel economy information. More recent amendments have added disclosure requirements for hybrid and electric vehicles.

Purchasers of new cars have long relied on window stickers as a reliable starting point for pricing and feature information. While specified information is required to be included in the window sticker—and in some cases a specific type size and area is required—the overall formatting of a window sticker remains discretionary. For this reason, different manufacturers and retailers produce a wide variety of formats.

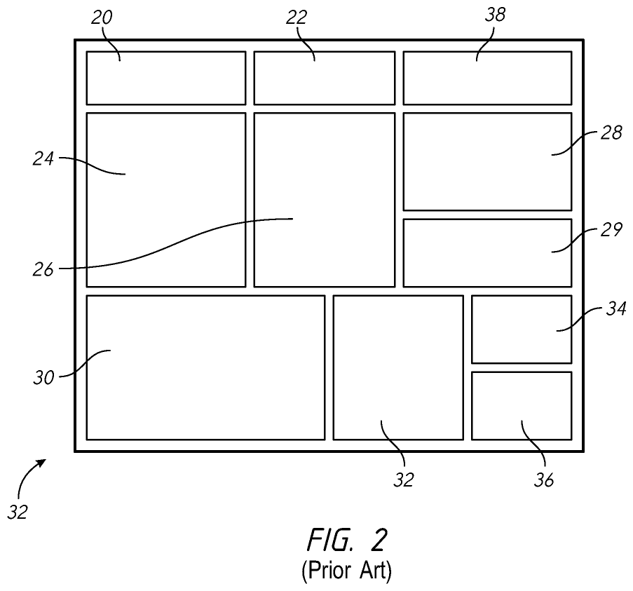

FIG. 2 graphically depicts one common format. Exemplary Monroney sticker 18 includes: manufacturer information 20 (such as “Ford Motor Co.”), model information 22 (such as “Mustang”), summary information 38, standard equipment information 24, warranty information 26, optional equipment information 28, pricing information 29, fuel economy information 30, crash rating information 32, parts content information 34, and vehicle identification number (VIN″) information 36.

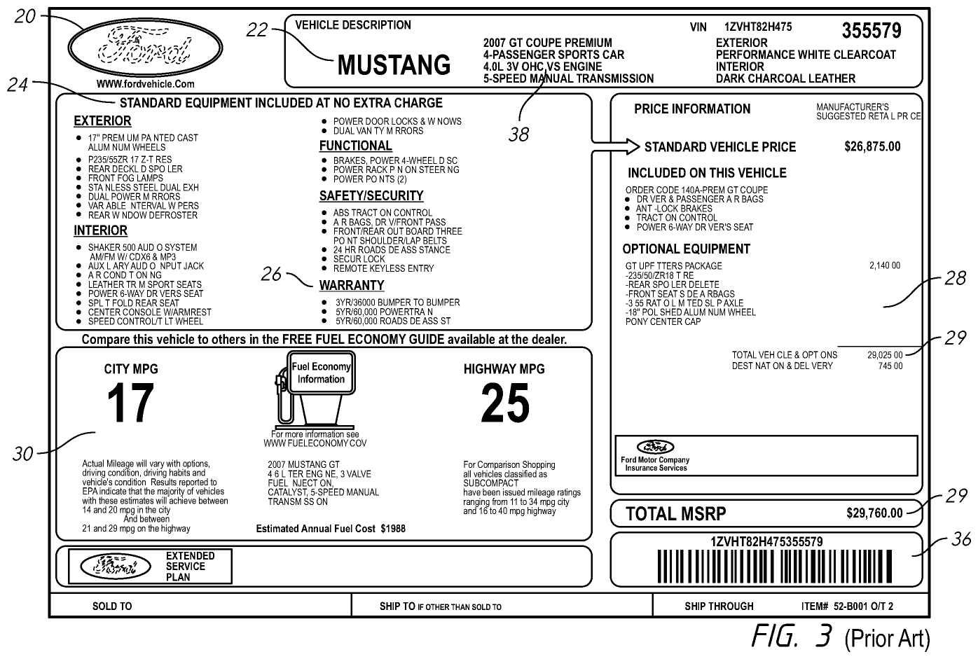

FIG. 3 graphically depicts an exemplary sticker for a Ford Mustang automobile. The “look and feel” of the stickers varies considerably from manufacturer to manufacturer even though all present the same basic information. In FIG. 3, for example, manufacturer information 20 is presented as a graphical logo. These variations are familiar o new car shoppers.

The sticker in FIG. 3 presents information that is quite useful to the purchaser. As an example, summary information 38 specifies that this vehicle is a “GT Coupe” having a “premium” trim package. It also specifies the engine type (4.0 L 3 V OHC VS engine) and the transmission type (5-speed manual transmission). The original paint color and interior colors are also provided.

Standard equipment information 24 includes a list of everything that should be present on the vehicle. All optional equipment is provided in optional equipment information 28. Of particular interest, the retail cost of every piece of optional equipment is also provides.

Until recent times, shopping for a new car commenced with a prospective buyer walking around a dealer's physical lot. This activity has now largely been replaced by web browsing, where a buyer may look through the inventory of many different dealers before ever physically visiting a lot. The window sticker is so widely known and so commonly used, however, that many dealers now post the window stickers for every vehicle as an electronic file that is available on line. Many of these electronic files are generated by the same system that generates the paper window sticker and so—for new vehicles at least—both the paper and electronic files are generally accurate.

However, the same cannot be said for the used vehicle market. Window stickers are not generally required for used motor vehicles. Even so, many used car vendors do actually create window stickers and physically place them on the car and post them online. The creation of such “aftermarket”window stickers has created many problems. The data needed to construct such a sticker is often inaccurate or at best incomplete. Further, the data is often hand-entered and this introduces additional errors. The result is an inaccurate window sticker.

A remotely located customer may view the window sticker and then travel many miles to physically inspect the car. Upon arriving the customer learns that the car actually has a lower options package than was stated in the sticker. Even worse, some customers actually purchase a car on the basis of the sticker information. A mistake in that information can form the basis of a breach of contract action. At best, the dealer will lose the sale and create an unhappy customer. Car dealers also have a need for the used-car window sticker, such as when a dealer is buying a vehicle at an auction. Used car auctions typically don't list the detailed option-packages on a used car. Thus, the window sticker is quite helpful in this situation.

A particular problem in this regard concerns the factory options included on a specific car when it was built. These are rarely indicated in the vehicle identification number (“VIN”). In order to determine the factory options it is often necessary to acquire the VIN and then consult the car builder's historical records for that particular VIN. These records are maintained in different physical locations and using widely different data formats.

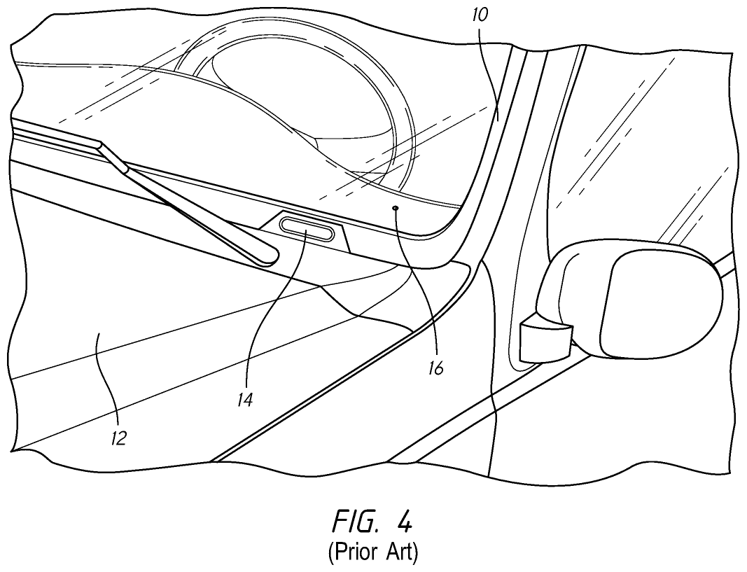

There are prior art data retrieval systems that retrieve data on the basis of a vehicle's unique vehicle identification number. All motor vehicles sold in the United States in the past few decades have been assigned a unique vehicle identification number. This is usually referred to as a vehicle's “VIN” or “VIN number.” FIG. 4 shows a common location for a VIN number 14. A plate or tag is provided by the vehicle manufacturer near the bottom of wind shield 16 adjacent to the intersection between hood 12 and A-pillar 10. The plate is protected by the wind shield while also being visible through the wind shield.

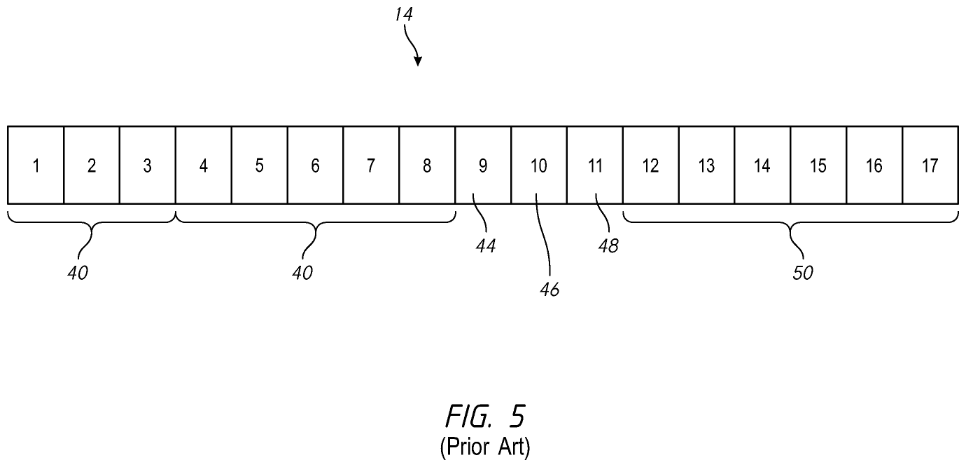

Since 1981 VIN numbers in the U.S. have followed a standard 17-character format. FIG. 5 illustrates this format. The numbers shown in the spacing (from 1 to 17) refer to the position in the format and not necessarily to a number that would ever appear in an actual VIN.

World manufacturer identifier 40 provides a unique identifier for the maker of the vehicle. Vehicle attribute section 42 is used by a manufacturer to identify aspects of a particular vehicle—such as engine type and body style. It is not standardized. Each manufacturer can use this section to encode information it would like included in the VIN. Check digit 44 is used to validate the rest of the VIN number.

Model year code 46 has been standardized for all U.S. vehicles since 1981. It follows an established sequence. Under the U.S. standard, the letters I(i), O(o), and Q(q) are not used anywhere in a VIN. U, Z, and the digit 0 are not used in the model year codes. Plant code 48 describes where the vehicle emerged from final assembly. This is assigned by the manufacturer. Serial number 50 is not standardized and each manufacturer tends to use its own system for identifying its own vehicles.

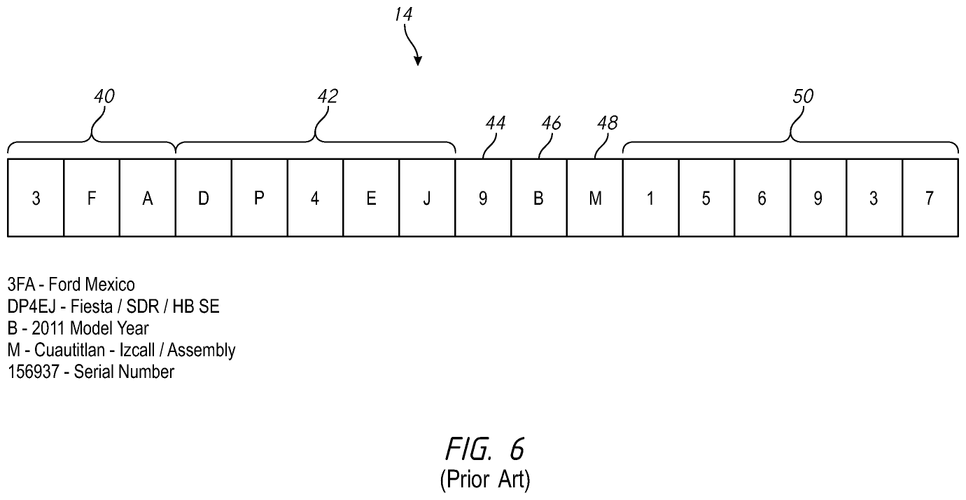

FIG. 6 shows an actual VIN number with annotations provided for the appropriate sections. World manufacturer identifier 40 in this example is “3FA,” which decodes as Ford Mexico. Attribute section 42 is “DP4EJ.” There is no general standard defining how to decode this sequence. However, in the standard system used by the Ford Motor Company, this sequence decodes to: Fiesta/5 door/hatchback/SE trim.

Model year code 46 is “B.” The model year codes advance from A-Y and then from 1-9 (recall that U, Z, and the digit 0 are not used). It is important to note that the model year codes repeat every 30 years. Thus, the code “B” was used for the 1981 model year and for the 2011 model year. Additional information may be needed to resolve this possible ambiguity. The VIN number presented is actually from the 1981 model year

Plant code 48 is “M.” This decodes as Ford's Cuautitlan-Izcalli assembly facility. Finally, the serial number 50 reads “156937.” This conforms to no general standard but does identify the vehicle within the manufacturer's internal standard.

From the preceding descriptions the reader will understand that a VIN uniquely identifies each vehicle sold in the United States (at least since 1981). In addition, the VIN provides information about the vehicle. However, the VIN by no means provides complete information about a vehicle. It does not, for example, provide enough information to create a complete Monroney sticker as depicted in FIG. 3. Significantly, it provides no information regarding the factory options that were added to the particular vehicle or the suggested retail price of those options.

What is needed is a product that takes a unique vehicle identifier and combines it with other available data sources to provide the relevant feature and pricing information for that vehicle. The present invention provides such a solution.

### BRIEF SUMMARY OF THE PRESENT INVENTION

The present invention comprises a system and method for creating an accurate motor vehicle “window sticker” using a vehicle identification number and external data sources. A software application is provided that can be located on a smartphone, The smartphone has a processor, an associated memory, and a digital camera. The digital camera is used to take a photo of the vehicle's VIN plate. The software application reduces this photo to a character sequence representing the vehicle's unique VIN. The system next determines the vehicle make and model year using the VIN and in some instances other data sources. Once the vehicle make and model year is determined, the system determines the correct remote data source from which to request historical build data for that vehicle. A query is sent to the appropriate data source(s) and detailed information concerning the features and pricing for the particular vehicle is obtained. A data source adapter is then applied to transform the retrieved data from each source into a usable form.

Next the inventive system cross references the data to verify its accuracy and ensure that the base and option pricing calculated is correct. Finally, the system uses the verified data to create a standardized window sticker in a format familiar to a prospective buyer. The window sticker may be presented in electronic form, physical form, or both.

This summary section is intended to provide a basic understanding of the invention. However, it is not intended to be read as limiting the scope of the invention or as providing an all-encompassing listing of the inventive features. The proper scope of the present invention should be determined by reviewing the claims that follow rather than this brief summary.

### BRIEF DESCRIPTION OF THE SEVERAL VIEWS OF THE DRAVINGS

FIG. 1 is a perspective view, showing a prior art motor vehicle with an attached window sticker.

FIG. 2 is a depiction of a format for a prior art Monroney sticker.

FIG. 3 is a depiction of a specific prior art Monroney sticker.

FIG. 4 is a perspective view, showing an exemplary prior art vehicle identification number on a motor vehicle.

FIG. 5 depicts the character sequence for a vehicle identification number such as used in the United States.

FIG. 6 depicts an exemplary vehicle identification number such as used in the United States.

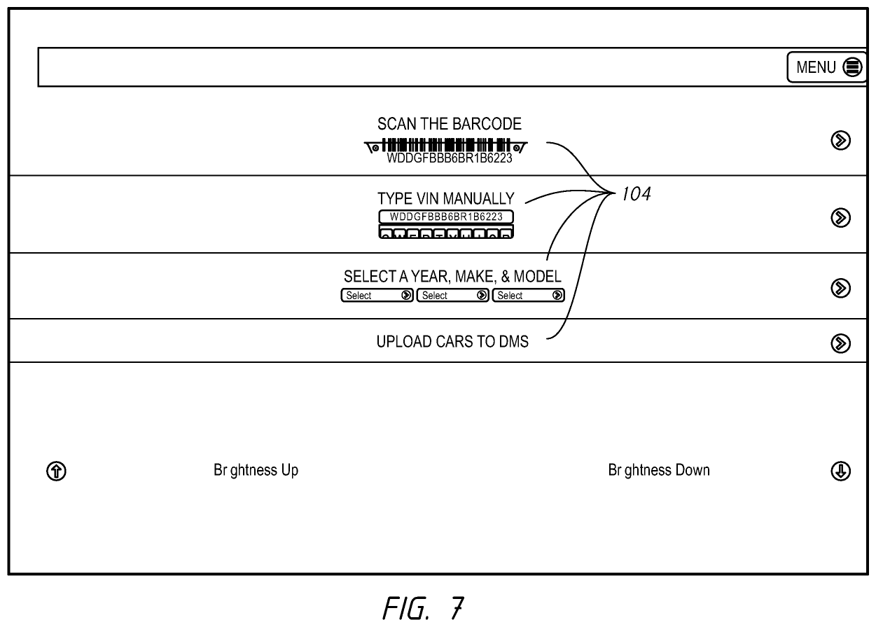

FIG. 7 is a screen shot of an exemplary graphical user interface used to implement the present invention.

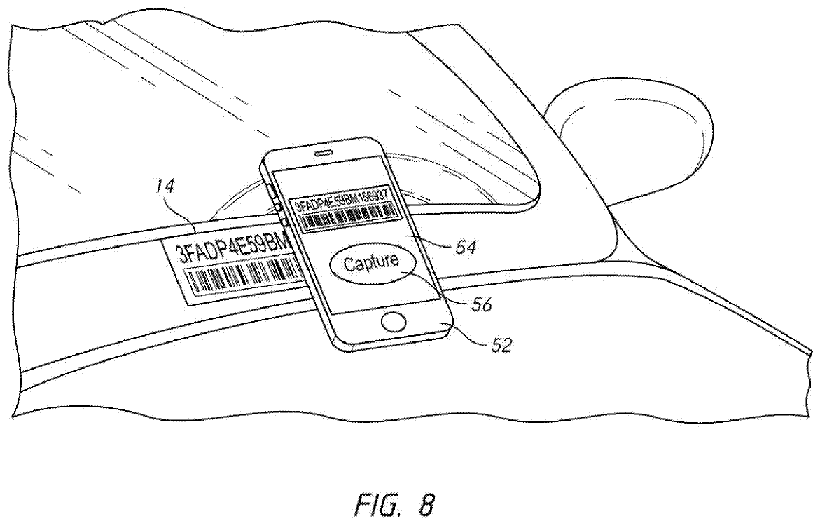

FIG. 8 is a perspective view, showing how a portable electronic device may be used to capture a vehicle identification number.

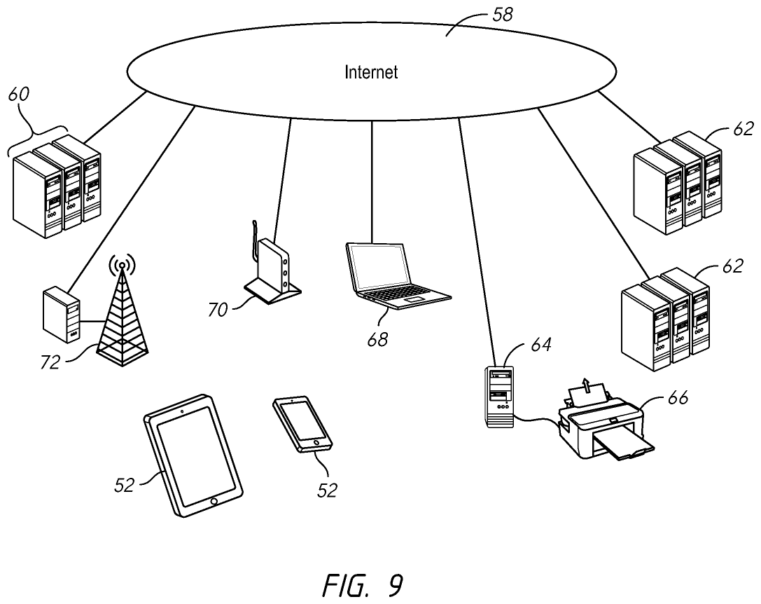

FIG. 9 is a schematic view, showing how the various computer hardware used in the present invention can communicate.

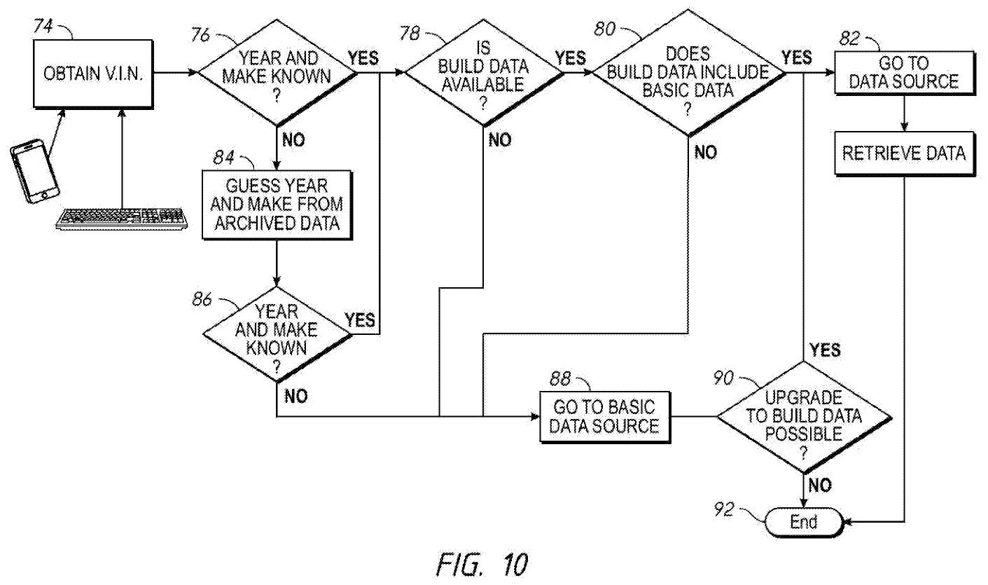

FIG. 10 is a flow diagram, showing some of the steps performed by the software used in the present invention.

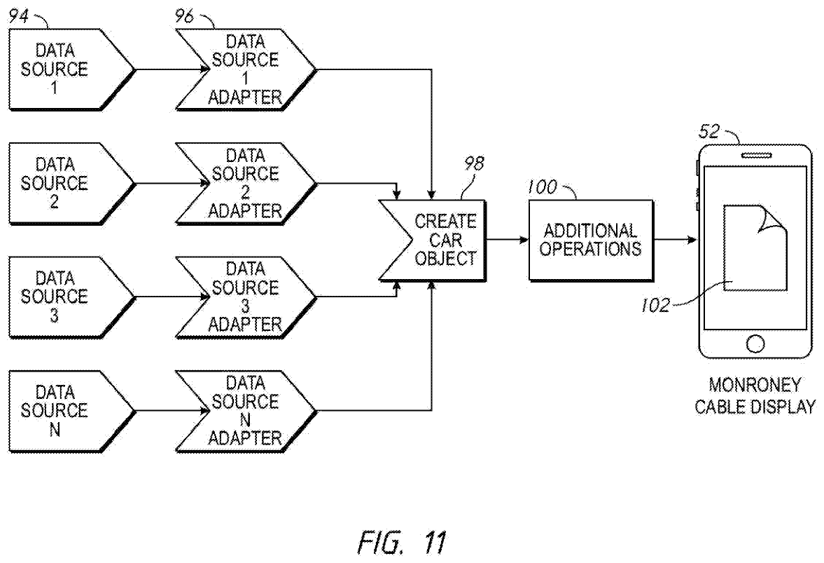

FIG. 11 is a flow diagram, showing some of the steps performed by the software used in the present invention.

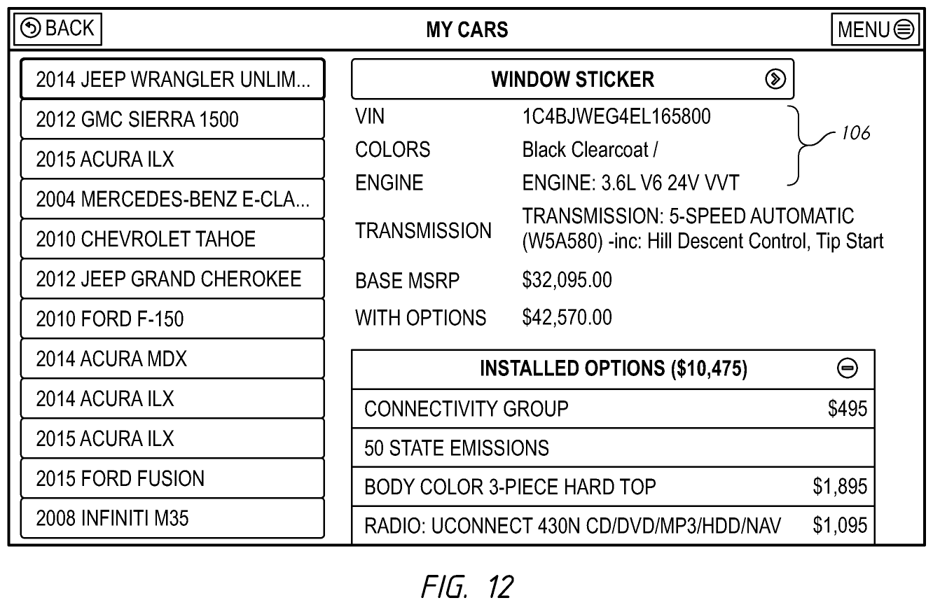

FIG. 12 is a screen shot of an exemplary graphical user interface used to implement the present invention.

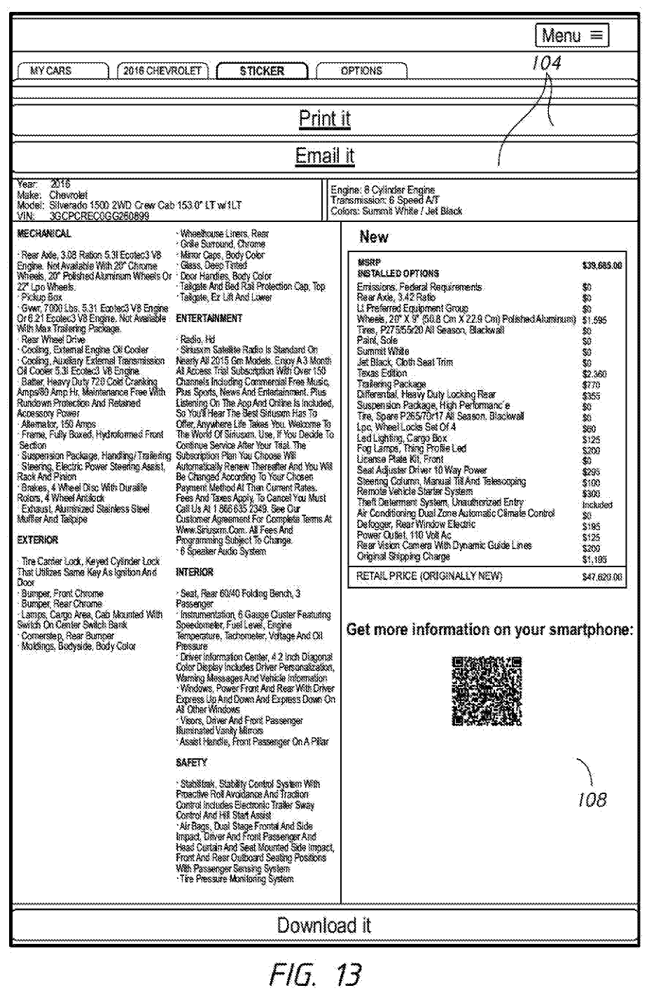

FIG. 13 is a screen shot of an exemplary graphical user interface used to implement the present invention.

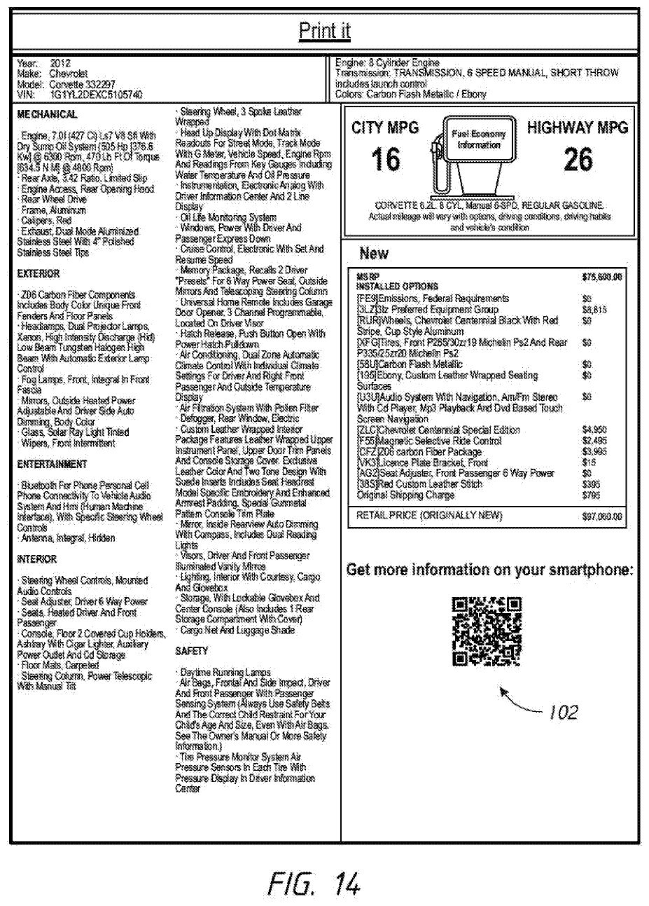

FIG. 14 is a screen shot of an exemplary graphical user interface used to implement the present invention.

### REFERENCE NUMFRALS IN THE DRAVINGS

4 car

6 window

8 window sticker

10 A-pillar

12 hood

14 vehicle identification number

16 windshield

18 Monroney sticker

20 manufacturer information

22 model information

24 standard equipment information

26 warranty information

28 optional equipment information

29 pricing information

30 fuel economy information

32 crash rating information

34 parts content information

36 VIN information

38 summary information

40 world manufacturer information

42 vehicle attributes

44 check digit

46 model year code

48 plant code

50 serial number

52 portable electronic device

54 display

56 command icon

58 Internet

60 application server

62 data server

64 desktop computer

66 label printer

68 laptop computer

70 wireless router

72 cell service provider

74 step

76 step

78 step

80 step

82 step

84 step

86 step

88 step

90 step

92 step

94 step

96 step

98 step

100 step

102 Monroney label display

104 optional selection

106 summary

108 preview

cl DETAILED DESCRIPTION OF THE INVENTION

The present inventive method and system uses a vehicle identification number (“VIN”) as its starting point. The VIN may be entered manually using a computer keyboard. It is more convenient for the user, however, to have an automated “capture” system. FIG. 7 illustrates a “screen shot” from a graphical user interface used to implement the inventive method. The depiction of FIG. 7 may be provided to the user as a display on a portable electronic device such as a smart phone. Optional selections 104 are provided to the user. These allow the user to scan an available VIN, manually enter a VIN, manually select a vehicle, or upload a vehicle (along with identifying information) from an external source. In this example the user elects to scan the VIN.

FIG. 8 shows the preferred scanning process. Portable electronic device 52 (a smart phone) includes a digital camera (facing away from the viewer in FIG. 7) and display 54. The smart phone includes a internal processor and an associated memory. An application is provided to the smart phone as part of the present inventive method. The application is and loaded in the smart phone's internal memory.

When the application is activated a graphical user interface (“GUI”) is provided on display 54. This GUI prompts the user to take the necessary steps to implement the process. A significant initial step is the acquisition of the VIN. The user aims the smartphone at VIN display 14 on a motor vehicle. An image of the VIN appears on display 54. The user manipulates the electronic device so that VIN 14 is fully visible on display 54. The application running on the device confirms the suitability of the image and then displays command icon 56. The user “presses” command icon 56 by touching the: screen. The image of the VIN is then temporarily stored on the smartphone. Application software running on the smartphone may then be used to recognize the characters contained within the image (optionally directly from the characters themselves but often through decoding a bar code or QR code that is provided adjacent to the stamped metal plate displaying the VIN). The VIN may then be stored as a simple character sequence.

The smart phone is equipped with wireless transceivers (typically for cell and WiFi communication). This wireless equipment is used by the inventive application running on the smartphone to transmit the VIN to remote application serves which then perform the next steps of the inventive method.

The invention may be implemented using a wide variety of computing devices and communication hardware, FIG. 9 depicts some exemplary hardware, The invention preferably includes one or more application servers 60 running suitable software with associated memory storage. Communications are preferably conducted over the Internet 58, since this will give the broadest possible access to portable devices. Suitable encryption may be used to ensure security.

A vehicle VINT will typically be captured by the inventive application running on a portable electronic device 52 (such as a smart phone or tablet). The VIN is then transmitted to application server 60 for processing. This transmission may pass through cell service provider 72 (typically in the case of a smart phone). It may alternatively pass through wireless router 70 (using WiFi) or some other channel,

Software running on application server 60 receives the VIN and uses information contained int eh VIN to determine which external data source it should query in order to obtain the historical build data for the vehicle associated with the VIN (more detail regarding how the external data source is selected is present subsequently). An external data request is then sent from application servers 62 to other databases, such as are housed on remote data servers 62. These requests preferably also pass via Internet 58.

An object of the present invention is the creation of an accurate Monroney sticker corresponding to the VIN submitted. Once the data comprising the Monroney sticker has been obtained by the software running on application servers 60, processed, and formatted, it may be passed back to the original requesting portable electronic device 52. It may also be passed to other devices such as laptop computer 68 or desktop computer 64. These data exchanges are preferably also made through Internet 58. The created Monroney sticker may be displayed on a cell phone or tablet display. It may be incorporated in web-based advertising. It may also be physically printed, such as by sending it to label printer 66.

The overall process can therefore be broadly summarized as follows:

(1) The user supplies a smart phone and downloads the inventive software application to the smart phone;

(2) The application presents a GUI on the smart phone that prompts the user to capture the vehicle's VIN (either by digital image and character recognition, by bar code scan, by QR code scan, or manual entry);

(3) The application reduces the VIN to a simple character sequence and transmits it to a remotely located application server (typically using cell communications and communications over the Internet);

(4) Software on the application server analyzes the VIN to determine which of the multiple possible remote databases it should send a query to. Once the correct database is determined, the application server formats the data query (using a data source adapter) for the selected database;

(5) The selected database returns a response from the query to the application server. The application server again applies a data source adapter to put the returned information in a standard format; and

(6) The application server uses the returned data in the now-standard format to create the standard Monroney label;

(7) The application server sends the created Monroney label back to the original smart phone (in a digital format) and to other recipients as desired and in other forms if desired.

Step (4)—analyzing the VIN to determine the proper remote database for a search query—is not always a simple matter, In fact, some VINs do not provide sufficient information to properly identify the search database. This may seem odd, as every VIN will identify the vehicle manufacturer. However, many manufacturers often maintain databases only for recently built vehicles. Data concerning older vehicles is often stored in a different location, and may even be stored with a contract data management company rather than the manufacturer itself

In addition, a single manufacturer often has multiple manufacturing facilities in different parts of the world. As an example, Ford Motor Co. has 18 currently-listed world manufacturing codes, representing facilities in 7 different countries. It is often not a simple matter to determine which database possesses the information needed to construct a Monroney label. One could, of course, format and send each VIN to every possible remote databases. This is impractical, however, as these remote databases require a fee for each search and response. It is therefore desirable to determine the: specific database needed before sending a query. The following descriptions provide a preferred embodiment of the inventive process, along with a preferred method of dealing with the problem of determining which database to query.

Those skilled in the art will know that the software needed to run the inventive process could be implemented in a virtually endless variety of ways. The following descriptions explain one way of implementing the process. FIGS. 10 and 11 provide flow diagrams for the operations carried out by the software in the inventive system. The inventive method can be broken down into two broad classes of operations. In the first class of operations, the method acquires a VIN and seeks to assemble from one or more external data sources all the information needed to create a Monroney sticker for the vehicle associated with that VIN. In the second class of operations the method takes the external raw data and combines and transforms it to create the standard Monroney label. FIG. 10 broadly depicts the data gathering process. FIG. 11 broadly depicts the data transforming process.

FIG. 10 describes the operations performed by the inventive software running on application server 60 shown in FIG. 9. The operations depicted in FIG. 10 start in the upper left with the obtaining of the vehicle identification number (“VIN”), shown on the diagram as step 74. This description will run through the flow chart as a whole before explaining individual portions in more detail. It is important for the data gathering process to determine the year and make for the vehicle (“year” meaning the year in which the vehicle was made and “make” meaning the identity of the manufacturer). This information is needed in order for the software to make an initial determination as to the external database it should access. For example, the business operating the inventive system may have data sharing agreements with General Motors, Ford, and other manufacturers. Even within one manufacturer, multiple databases often exist for different age ranges of vehicles. A charge is generally assessed for accessing each data source. Thus, one does not want the software to send requests to all possible vehicle data sources. Rather, the software preferably determines the year and make for the vehicle and then sends a request to the appropriate database or databases.

Even for recently made vehicles it is sometimes necessary to access more than one remote database. The available data can be divided into Basic Data and Build Data, and these are sometimes stored in more than one database. The concepts of Basic Data and Build Data will be explained with respect to the exemplary Monroney label shown in FIG, 3. Basic Data includes the make and model of the vehicle, along with the body type, engine, and transmission. For the example shown, the Basic Data includes the facts that the vehicle is a Ford Mustang, GT Coupe, with the 4.01, 3 V OHC VS engine, and a 5-speed manual transmission. The Build Data tends to be the data needed to build one specific variation of the car. In the example of FIG. 3, the Build Data includes the facts that the car was made according to the “Premium” package of options, the exterior color, the interior color and material, and that the vehicle was built with the “GT Upfitters package.” The Basic Data and the Build Data also include manufacturer's suggested retail pricing data for each included option.

Returning now to FIG. 10—at step 76 the software takes the VIN and determines whether the year and make are known. If the answer is “yes” the software next determines whether Build. Data is available for that year and make (step 78). If the answer to that question is “yes” the software next determines whether the Build Data includes Basic Data (step 80). If the answer to that question is “yes” then the software selects the appropriate remote data source, sends a properly-formatted query to that remote data source, and retrieves the Build Data and the Basic Data for the particular VIN (step 82). The portion of the steps carried out by the inventive software shown in FIG. 9 then proceeds to end step 92.

If at step 76 the software determines that the make and model year are not known, then the software proceeds to “guess” a year and make from archived data. This optional step is a significant part of the inventive process. The inventive system conducts many, many searches in response to data requests from many sources. For each such search application server 60 creates an entry in its own database. This local search database may be stored in memory that is associated with application server 60, stored in remote memory that is accessible to application server 60, or stored in any other desired fashion. This local search database includes—for every search conducted by the inventive system—the VIN, the data retrieved, and the identity of the remote database that actually provided the information for the vehicle.

In some instances it will not be possible to determine the proper remote database prior to formatting and sending a query. In that case the software running on application server 60 will send multiple queries to multiple remote databases. One of these databases will return data for that VIN and the identity of this database will then be logged in the local search database.

The local search database becomes quite useful when the make and model year is not immediately known from the VIN submitted. As an example, a customer may submit a search request using a VIN from a 1988 Land Rover Vehicle—SALHV1141JAnnnnnn. In this case “SA” indicates that the vehicle was made in the United Kingdom. “L” indicates that the vehicle was made by Land Rover. The model year code “J” (the 10^{th} digit) indicates one of two possible model years. It could be 1988 or it could be 2018.

It may seem that the make of the vehicle can always be easily determined from the VIN, but this is not necessarily true in terms of which remote database should be searched. This 1988 Land Rover vehicle provides a good example, At the time this vehicle was made Land Rover was part of British Leyland Motor Corporation. In 1994 Land Rover was sold to BMW. In 2000 BMW sold Land Rover to Ford Motor Company. In 2008 Tata Motors bought Land Rover from Ford. Thus, this vehicle provides a good example of how Build Data can pass through many hands and how it is not clear which “make” would possess the data at the time the search is conducted.

Application server 60 ultimately formats and sends queries to multiple remote databases (such as the database custodians for Leyland, BMW, and Ford). A good response to this query will then be stored in the local database for future use (There may be multiple good responses). The significant portion of the response (in terms of properly identifying the right remote search database) is the world manufacturer code and model year code.

Returning now to the process shown in FIG. 10—when a future VIN query comes in containing an ambiguity regarding year and make, the inventive system checks the new VIN against the local database showing VINs searched in the past and the identity of the remote databases having good data. The significant portions of the VIN are primarily the world manufacturer code and the model year code. The current VIN request would then be reduced to SALnnnnnnJnnnnnnn (The n's represent wildcard characters in this sequence). The comparison would then reveal a local database match to the prior search conducted for SALHV1141JAnnnnnn (A local database match does not mean that the entire VIN matches but instead that the relevant portions of the VIN match—in this example the world manufacturer code and the model year code. In other instances additional fields may need to be matched—such as the attribute section). The local database would then reveal that good Build Data and Basic Data was obtained from a remote database associated with the Ford Motor Company, The system would then format and direct a search only to the Ford database. Thus, the system avoids having to pay for multiple searches by learning from its past searches.

Looking at step 84 in FIG. 10, if the comparison to the local database gives a match then the process returns to step 78 and proceeds. If the “guess” is unsuccessful then the process proceeds to step 88. In step 88 the software consults a “Basic Data source.” This is one or more external data sources that are useful in decoding some VINs (but which do not provide complete Build Data).

If the Basic Data source supplies the make and model information, the software then proceeds to step 90, which asks whether it is possible to upgrade the Basic Data to Build Data. If the answer at step 90 is “yes” then the software proceeds to step 82 and the external Build Data is retrieved. If the answer at step 90 is “no” then the software proceeds to end step 92. This result may be deemed only partially successful. It will be possible using the Basic Data to create a Monroney sticker having some useful information, but it will not be complete.

Step 78 asks whether Build Data is available once the vehicle's year of production and make are known. If the answer to this question is “no” then the software moves to step 88 (querying a Basic Data source). The steps then proceed as describe previously.

Step 80 asks whether the Build Data includes Basic Data. This may seem somewhat odd, since Build Data is more comprehensive than Basic Data. However, some databases of Build Data include detailed information (such as interior trim and stereo options) but do not include Basic Data. In such an instance the inventive process returns to step 88 (seeking Basic Data from another source). The process would then proceed to step 90 and would then progress as explained previously.

The operations of FIG. 10 will now be described with another example. The inventive system may start with the vehicle identification number 3FADP4EJ9BM156937. The software focuses on digits 1-8 and 10-11. The reader will recall from the prior descriptions that these portions of the VIN contain (in this particular example):

3FA—world manufacturer identifier

DP4EJ—vehicle attributes

B—date code

M—manufacturing plant code.

The make is decoded as “Ford Mexico.” The model year code is “B.” The reader will also recall that year codes repeat every 30 years. The code “B” decodes as either 2011 or 1981 (Note that for vehicles older than 2009 this isn't a problem because no 17-digit VIN was standardized for 1979 or before). However, the ambiguity problem will grow over time since more and more VIN's will be from the post-2009 period). It is necessary to know whether the VIN data code represents a 2011 vehicle or a 1981 vehicle in order to most efficiently carry out the inventive process. The data for Ford vehicles of 1981 may not be in the same location as for Ford vehicles for 2011, meaning that it is desirable to resolve this ambiguity prior to sending out data requests and possibly incurring needless data charges.

One solution is simply to present a question back to the user entering the VIN. An application running on a smart phone could present a message to the user: “This VIN is either for a 2011 vehicle or a 1981 vehicle.” The user could then be provided with selection icons to enter an answer (An example of this is shown as an optional selection 104 in the screen shot of FIG. 7). The user might not actually know the model year (recall that the user might be a car dealership employee walking around a lot scanning dozens of vehicles). Nevertheless, most any user will be able to correctly guess between the two possibilities—since they are 30 years apart.

It is preferable, however, to perform the disambiguation automatically. This is where step 84 in FIG. 10 comes in. The reader will recall in the embodiment presented that the software implementing portions of the inventive process runs on an application server or servers, The same software may be given access to a large database of search operations already run. The software then focuses on the portions of the VIN that are useful for disambiguation (digits 1-8 and 10), The VIN 3FADP4EJ9BM156937 then becomes 3FADP4EJnBnnnnnnn (the “n” indicating a “wildcard” in the sequence). The software next searches the associated memory to determine if any prior search has been done on a VIN conforming to 3FADP4EJnBnnnnnnn. The software determines that such a search has been performed before and that the information ultimately retrieved was for a 2011 Ford Fiesta. In this case the “guess” was successful and the process then proceeds to step 78 in FIG. 10.

Of course, when the system first begins running, this type of matching against prior searches in the local database will not be possible. In such a case there may be no choice but to send data requests out to multiple external data sources. For example, a first data source might cover Ford products from 1970-1979, while a second data source might cover Ford products from 1996 to the present. A data request for the VIN 3FADP4EJ9BM156937 could be sent to both data sources. The 1970-1979 data bases would then return a “no such record” error while the later database would return a record “hit.” This information would then be stored by application server 60 both for use in creating a Monroney sticker (the present task) as well as for use in disambiguating future searches.

The software preferably creates an object or class called “Basic Data.” This includes basic information about a vehicle such as its make, model, model year, body style (hatchback, sedan, etc.), and engine type. The software preferably also creates an object or class called “Build Data.” Build Data inherits from Basic Data.

It is important for the reader to appreciate that the Basic Data and Build Data objects are not previously-completed objects that are retrieved from an external source. Rather, the inventive software creates these objects by using data acquired from multiple external sources. As an example, the operator of the inventive system may have an agreement with an automobile manufacturer giving it access (on a paying basis) to the manufacturer's vehicle manufacturing data. The manufacturing data generally refers to all the information the manufacturer used to equip a particular vehicle when it was made. For example, a particular vehicle might have three basic interior trim levels available. However, those three trim levels might be available in 49 different color combinations. In addition, there might be 45 additional interior options available (such as an auto-dimming rear view mirror, an 8-speaker sound system, etc.). At the time the vehicle was built, all the installed options were listed in the manufacturing data. This information is retrieved by the inventive system from the data source that archives it.

The inventive system might then retrieve pricing data from a second data source. This pricing data can be used to append a price to each option found in the manufacturing data. The inventive system might also retrieve basic information from a third data source (such as the vehicle's body type and model name). It might seem odd that this information would not be contained in the manufacturing data but sometimes it is not. The inventive system ultimately seeks to compile all this information into a single Build Data object. The general operations involved in completing the Build Data object and ultimately creating a Monroney sticker are shown in FIG. 11.

Once the appropriate data are retrieved from the separate sources, the data must be transformed into a usable format and then used to create a desired end product. Data sources 1 through n may assume a wide variety of forms and formats even where they contain essentially the same information. For example, Data source 1 might store a vehicle's base suggested retail price as:

@msrp⇒“24,900.00”

Data source 2 might store the exact same information as:

Base_msrp:24900

In the embodiment depicted, a data source adapter 96 is provided for each data source the system accesses. The data source adapter is programmed to retrieve and organize the desired information in the data and convert it into a consistent format that is used for subsequent internal operations. For example, the inventive system might define an internal variable called “BASE_MSRP” After the information is retrieved it is converted into a value for the variable “BASE_MSRP” regardless of the format of the original data. Data source adapters may also call other adapters and perform internal calculations in order to create a consistent format.

Step 98 takes all this available information and uses it to create a class or object named Car Object. Car Object contains all the information obtained for a particular VIN, transformed into a format that is similar o the final window sticker format. Additional operations (100) are then performed to create the final data that is ready to be used for the Monroney label.

The additional operations may assume many forms. As one example, it is often necessary to apply algorithms to avoid duplications in the pricing data. For instance, a particular vehicle may have come equipped with the “LS comfort package” (This is an “option group package” meaning a clustering of multiple options into a group with one total price). The LS comfort package shows a manufacturer's suggested retail price of $4,200. In the manufacturing data, there are line items for “steering wheel stereo controls” and “heated seats,” both of which carry an additional price as an added option. The MSRP for the steering wheel controls is $800 while the MSRP for the heated seats is $550. In step 100, the software determines that both the steering wheel controls and the heated seats are included in the “LS comfort package.” The software then ensures that the individual MSRP's for the options are not included in the calculation of the total vehicle MSRP, since that would produce a double counting.

Once the additional calculations are performed, the software formats the data for presentation as a familiar Monroney label 102. In the example of FIG. 11, the Monroney label is presented as an image on a digital device. Differing levels of detail can be provided for the presentation, possibly depending upon the size of the display screen available.

FIG. 12 shows a summary depiction of the Monroney label—such as might be suitable for presentation on a small screen on a smart phone. Summary 106 provides the most basic information that is customarily used to compare one vehicle to another.

FIG. 13 presents a more detailed depiction, conforming to the level of detail typically found on a physical window sticker. Preview 108 is intended to be a “what-you-see-is-what-you-get” depiction. Optional selections 104 allow the user to print the completed label or email it to a selected address. The label can be graphically presented as a display on a digital device or as a physical window sticker.

FIG. 14 shows a larger depiction of Monroney label display 102. The exemplary interface then allows the user to select a print icon to produce a physical print conforming to the depiction.

Returning now to FIGS. 10 and 11, some of the terminology used will be explained in more detail. The inventive process is carried out on a first computer system (such as application server 60) having an associated memory storing the local database. The associated local database does contain some vehicle records. These may be used in step 86 to determine a year and make for the current VIN by comparing it against previously-searched VIN's and the records returned for those previously-searched VIN's as explained previously. However, most of the data retrieved by the inventive software will be retrieved from remote databases. In other words, the inventive software will send a VIN-data request (typically over the Internet) to a data source hosted by a remote server and receive a reply from that remote server.

In FIG. 11, the retrieved data is used to create a car object in the software (step 98). This could more generally be described as the creation of a “software vehicle object” (since the inventive system can be used for vehicles other than cars). The software vehicle object preferably contains all the information needed to create a Monroney sticker or label. This would include:

1. Vehicle make;

2. Vehicle model;

3. Vehicle model year;

4. Color;

5. Engine and transmission type;

6. VIN;

7. All options;

8. Base MSRP;

9. MSRP for all options; and

10. Information needed to avoid double counting of an individual option that is also part of an option group package.

The software and hardware implementing the inventive process may include many other features and combinations of features in addition to those disclosed for the preferred embodiments. These include:

1. The entire process could be configured to run as a “stand-alone” application on a single computing device, as long as the computing device had access to the external resources containing the vehicle information;

2. The data exchanges could be done using dedicated data lines rather than via the Internet;

3. The graphical user interface could assume a different form;

4. A command-based interface could be used instead of a graphical user interface;

5. The VIN capture can be made by reading a bar or QR code in a vehicle's documentation rather than the VIN plate itself; and

6. The inventive process may be made available to a consumer as a downloadable “app” (application) running on a portable device such as a smart phone or tablet.

Although the preceding description contains significant detail, it should not be construed as limiting the scope of the invention but rather as providing illustrations of the preferred embodiments of the invention. One skilled in the art may easily devise variations on the embodiments described. Thus, the scope of the invention should be fixed by the claims rather than the examples given.

Having described my invention, I claim:

1. A method allowing a user with a smart phone having a display, processor, an associated memory, a wireless communication capability, and a digital camera to retrieve a Monroney label created for a specific vehicle, comprising:
(a) providing an application residing in said memory on said smart phone and running on said processor in said smart phone;
(b) said application providing a graphical user interface on said display of said smart phone, said graphical user interface prompting said user to capture a vehicle identification number for said specific vehicle;
(c) providing a system server;
(d) said application using said wireless communication capability of said smart phone to transmit said vehicle identification number to said system server;
(e) said application server using said vehicle identification number to select a correct remote database for a retrieval of data pertaining to said specific vehicle among a plurality of such remote databases;
(f) said application server formatting a data query and sending said data query to said correct remote database;
(g) said application server receiving a data response from said correct remote database;
(h) said application server using said data response to create a formatted Monroney label for said specific vehicle; and
(i) said application server transmitting said formatted Monroney label hack to said smart phone.

2. The method allowing a user to retrieve a Monroney label created for a specific vehicle as recited in claim 1, comprising said application server creating a local database of vehicle identification numbers searched and remote databases providing valid data for each of said vehicle identification numbers searched.

3. The method allowing a user to retrieve a Monroney label created for a specific vehicle as recited in claim 2, comprising:
(a) comparing said vehicle identification number received from said smart phone against said local database in order to find a local database match;
(b) determining which remote database returned good data for said local database match; and
(c) formatting a data query for said same remote database that returned good data for said local database match.

4. The method allowing a user to retrieve a Monroney label created for a specific vehicle as recited in claim 1, comprising sending said formatted Monroney label to a computing device in addition to said smart phone.

5. The method allowing a user to retrieve a Monroney label created for a specific vehicle as recited in claim 1 wherein said formatted Monroney label is a digital file that said smart phone can send to another device.

6. The method allowing a user to retrieve a Monroney label created for a specific vehicle as recited in claim 1, comprising:
(a) said application server sending a first data query for Build Data to a first remote database; and
(b) said application server sending a second data query for Basic Data to a second remote database.

7. The method allowing a user to retrieve a Monroney label created for a specific vehicle as recited in claim 3, comprising:
(a) said application server sending a first data query for Build Data to a first remote database; and.
(b) said application server sending a second data query for Basic Data to a second remote database.

8. A method allowing a user with a smart phone having a display, processor, an associated memory, a wireless communication capability, and a digital camera to obtain a Monroney label created for a specific vehicle, comprising:
(a) providing an application residing in said memory on said smart phone and running on said processor in said smart phone;
(b) said application providing a graphical user interface on said display of said smart phone, said graphical user interface prompting said user to provide a vehicle identification number for said specific vehicle;
(c) providing a system server;
(d) said application using said wireless communication capability of said smart phone to transmit said vehicle identification number for said specific vehicle to said system server;
(e) said application server using said vehicle identification number to select a correct remote database for a retrieval of data pertaining to said specific vehicle among a plurality of possible remote databases;
(f) said application server formatting a data query and sending said data query to said selected remote database;
(g) said application server receiving a data response from said selected remote database;
(h) said application server using said data response to create a formatted Monroney label for said specific vehicle; and
(i) said application server transmitting said formatted Monroney label back to said smart phone.

9. The method allowing a user to retrieve a Monroney label created for a specific vehicle as recited in claim 8, comprising said application server creating a local database of vehicle identification numbers searched and remote databases providing valid data for each of said vehicle identification numbers searched.

10. The method allowing a user to retrieve a Monroney label created for a specific vehicle as recited in claim 9, comprising:
(a) comparing said vehicle identification number received from said smart phone against said local database in order to find a local database match;
(b) determining which remote database returned good data for said local database match; and
(c) formatting a data query for said same remote database that returned good data for said local database match.

11. The method allowing a user to retrieve a Monroney label created for a specific vehicle as recited in claim 8, comprising sending said formatted Monroney label to a computing device in addition to said smart phone.

12. The method allowing a user to retrieve a Monroney label created for a specific vehicle as recited in claim 8 wherein said formatted Monroney label is a digital file that said smart phone can send to another device.

13. The method allowing a user to retrieve a Monroney label created for a specific vehicle as recited in claim 8, comprising:
(a) said application server sending a first data query for Build Data to a first remote database; and
(b) said application server sending a second data query for Basic Data to a second remote database.

14. The method allowing a user to retrieve a Monroney label created for a specific vehicle as recited in claim 10, comprising:
(a) said application server sending a first data query for Build Data to a first remote database; and
(b) said application server sending a second data query for Basic Data to a second remote database.
